(19) United States
(12) Patent Application Publication
(10) Pub. No.: US 2025/0037171 A1
(43) Pub. Date: Jan. 30, 2025

(54) SYSTEM AND METHOD FOR FLOW PREFERENCE VIA WATERFALLING MECHANISM AND APPLICATIONS THEREOF

(71) Applicant: YAHOO ASSETS LLC, New York, NY (US)

(72) Inventors: Naama Haramaty-Krasne, Kfar-Yehoshua (IL); Oren Shlomo Somekh, Kfar-Netter (IL); Yohay Kaplan, Haifa (IL); Tal Cohen, Even-Yehuda (IL); Daniel Haddad, Tel Aviv (IL)

(21) Appl. No.: 18/359,385

(22) Filed: Jul. 26, 2023

(51) Int. Cl. G06Q 30/0273; G06Q 30/0241

(52) U.S. Cl. CPC G06Q 30/0275; G06Q 30/0277

(57) ABSTRACT

The present teaching relates to method, system, medium, and implementations for online advertising. Bids are solicited from multiple bidders for an online ad display opportunity. A current value of a budget factor is retrieved and used for computing, for each advertisement corresponding to a respective bid, a wrapper function value based on the current value of the budget factor and a flow type of the advertisement. Based on the wrapper function value for each advertisement, a ranking score is determined and used to rank the advertisements associated with the bids. A winning bid is accordingly selected based on the ranking scores.

### BACKGROUND

### 1. Technical Field

The present teaching generally relates to computers. More specifically, the present teaching relates to data analytics and application thereof.

### 2. Technical Background

With the advancement of the Internet, most people in society nowadays conduct their daily affairs online, including consuming different types of content (articles, images, or videos), checking out various products, making purchases of just about everything, enjoying entertainment, receiving/providing education, or even taking virtual vacations. Such a shift in social behavior has motivated most entities, including individuals, companies, organizations, universities, or interest groups, to place a tremendous amount of information on the Internet. In the meantime, advertisers are also shifting their operation to online advertising and online content providers accordingly monetize their platforms to conduct ad campaigns for ad opportunities by seeking bids from different advertisers and then selecting winners that maximize their financial return.

FIG. 1 illustrates a real time bidding (RTB) framework 100 for online ad spot auction framework 100, where an ad opportunity auctioneer 110 may utilize its online platform for hosting content, e.g., a webpage 130-1, and act as an ad opportunity auctioneer to solicit bids on a vacant spot 130-2 for display an advertisement whenever webpage 130-1 is displayed to an online user. The solicitation may be sent to a plurality of bidders 150 via a network 140. Upon receiving the bids from bidders 150 via the network 140, the ad opportunity auctioneer 110 may select a winning bid based on various parameters and criteria stored in a storage 120. The webpage with winning advertisement to be displayed therein may then displayed to a user as webpage 160 with content 160-1 as well as the winning advertisement 160-2 associated with the winning bid displayed therein.

There may be other types of online advertising frameworks. For example, an online advertising platform may be provided with advertisements in advance from different sources, including, e.g., advertisers, companies that sell products, or manufacturers that make products for sale. The advertisements received in advance may be archived so that when an online ad display opportunity emerges, the online advertising platform may select, from the archived advertisements (without RTB), an appropriate winning advertisement for the display opportunity. Some online advertising frameworks may be set up to operate both RTB process and selecting from archived advertisements for each online ad display opportunity.

In selecting a winning advertisement, different factors/criteria may be considered with respect to various aspects associated with online advertising. FIG. 2A illustrates different types of parameters for determining a winning advertisement. For example, such parameters may include bid-floor, winner selection criterion, . . . , and budget involved in the campaign. A bid floor specifies the lowest bid accepted in a bidding process. Winner selection criterion may be related to some financial goal to be maximized such as maximized revenue to auctioneer via estimated click-through rate (CTR) or conversion rate (CVR). A budget may be spent via budget pacing for monitoring and managing the budget spending on advertisement within an organization. Budget pacing may be controlled by comparing the actual spending to a budgeted amount, which may be represented by a budget factor (BF) that provides an insight on whether the organization is on track to meet its financial goals. FIG. 2B illustrates the concept of a budget factor and it is traditionally a multiplier to be applied to an original bid amount and helps to determine the total budget available, corresponding to the amount of money that can be spent without exceeding the financial constraints.

The budget pacing control in traditional ad campaigns treats each of the received bids, ignoring the difference in the financial potential of each received bid and making it deficient to maximize the financial return. Thus, there is a need for a solution that addresses the issues discussed above.

### SUMMARY

The teachings disclosed herein relate to methods, systems, and programming for online advertising. More particularly, the present teaching relates to methods, systems, and programming related to budget management in online advertising.

In one example, a method, implemented on a machine having at least one processor, storage, and a communication platform capable of connecting to a network for online advertising. Bids are solicited from multiple bidders for an online ad display opportunity. A current value of a budget factor is retrieved and used for computing, for each advertisement corresponding to a respective bid, a wrapper function value based on the current value of the budget factor and a flow type of the advertisement. Based on the wrapper function value for each advertisement, a ranking score is determined and used to rank the advertisements associated with the bids. A winning bid is accordingly selected based on the ranking scores.

In a different example, a system is disclosed for online advertising. The disclosed system includes a bid processing unit, a wrapper function determiner, and a waterfall winning bid determiner. The bid processing unit is provided for processing bids solicited from multiple bidders for an online ad display opportunity. The wrapper function determiner is provided for retrieving a current value of a budget factor that is used to control budget pacing in online advertising, and, for each of the received bids, computing a wrapper function value based on the current value of the budget factor and the type of flow of the advertisement associated with the bid. The waterfall winning bid determiner is provided for ranking the received bids in accordance with ranking scores for the respective received bids computed based on the wrapper function values of the respective advertisements associated therewith and selecting a winning bid from the received bids based on the ranking scores.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for online advertising. The information, when read by the machine, causes the machine to perform various steps. Bids are solicited from multiple bidders for an online ad display opportunity. A current value of a budget factor is retrieved and used for computing, for each advertisement corresponding to a respective bid, a wrapper function value based on the current value of the budget factor and a flow type of the advertisement. Based on the wrapper function value for each advertisement, a ranking score is determined and used to rank the advertisements associated with the bids. A winning bid is accordingly selected based on the ranking scores.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an ad opportunity bidding framework for online advertising;

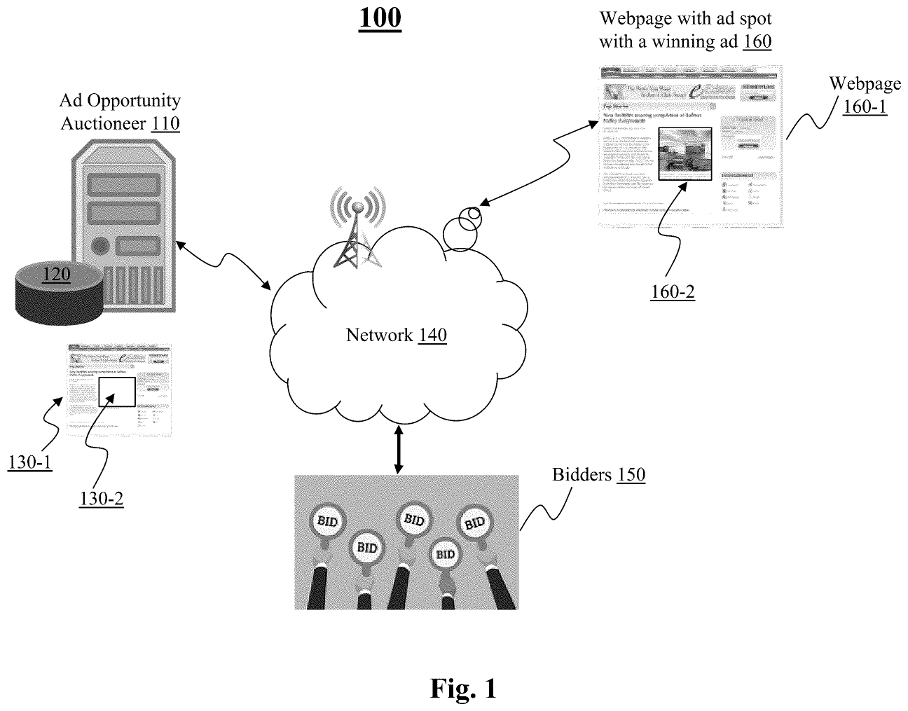

FIG. 2A illustrates different types of parameters to be considered in a bidding process;

FIG. 2B visually illustrates the concept related to the concept of budget factor used in a bidding process;

FIG. 2C shows different types of ad flows that may be involved in an ad campaign;

FIG. 3A depicts an exemplary high-level system diagram of an ad opportunity auctioneer, in accordance with an embodiment of the present teaching;

FIG. 3B is a flowchart of an exemplary process for an ad opportunity auctioneer, in accordance with an embodiment of the present teaching;

FIG. 4A depicts an exemplary high-level system diagram of a wrapper function determiner, in accordance with an embodiment of the present teaching;

FIG. 4B is a flowchart of an exemplary process of a wrapper function determiner, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

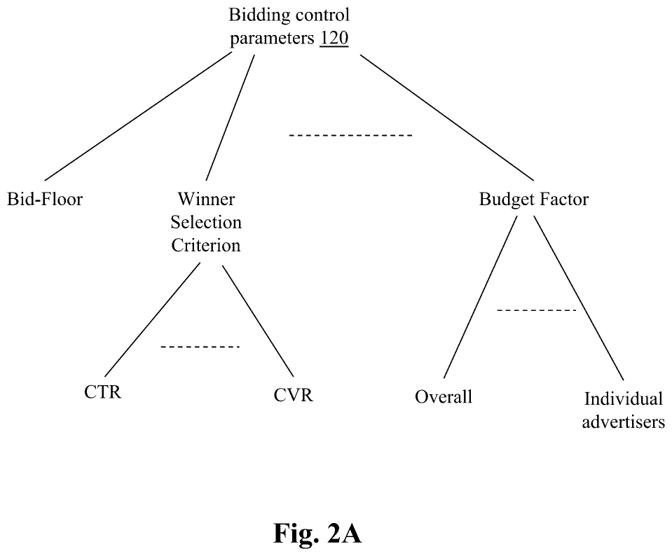

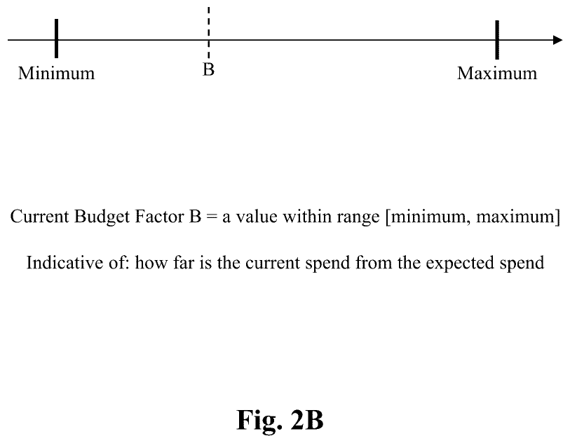

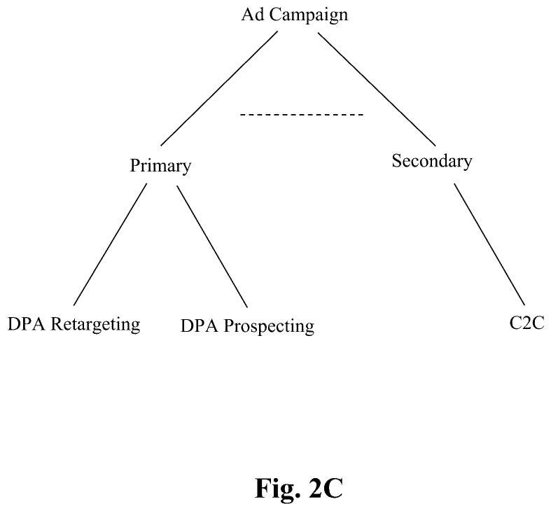

The present teaching discloses an exemplary framework for developing a wrapper function to the budget factor to enable the configuration to allow the capability of implementing a preference towards certain type of flow over others in ad campaigns. The ability of dynamically determining a wrapper function to the budget factor during an ad campaign may be utilized to adaptively maximize an auctioneer's financial return which may be specified according to, e.g., application needs or the financial objectives of the auctioneer. In online advertising, there may be different types of flows. In some examples, there may include two types of flow: primary and secondary, as illustrated in FIG. 2C. For instance, the primary flow may include dynamic product ad (DPA), which is a type of online advertising designed for, e.g., e-commerce merchants, such as Amazon, Walmart, and Macy's. With DPA, merchants provide their product catalogs having millions of products for selection to automatically create a personalized ad experience for the users. DPA has two main types of campaigns, retargeting and prospecting. Retargeting serves users that have shown an interest in certain products in the past; while prospecting strives to expand the advertisers' audience by presenting products to users who have not yet interacted with. Examples of the secondary flow may include native catalog-to-carousel (C2C) advertisements, corresponding to carousel ads, which combine multiple products into a single carousel ad. Products to be combined in a single carousel ad may be selected in advance according to some criteria.

In online advertising, a budget factor BF usually specifies a range [min, max] as shown in FIG. 2B, where minimum often corresponds to 0 and maximum to 1. The maximum may correspond to the maximum value of the original bid the advertiser set so that the maximal budget factor is 1. When the budget factor is close to 1, it means that the original bid is close to the budget depletion speed as expected. When the budget factor is 1, it means that the spend does not reach the goal. When the budget factor is close to 0, it means that the campaign is depleting its budget so that the final bid needs to be reduced significantly. The budget factor is used as a multiplier applied to the original bid amount. The present teaching provides a wrapper function to the budget factor to enable a waterfall mechanism to dynamically determine preferred flow (e.g., prefer the primary flow over the secondary flow) in a dynamic situation. The wrapper function value as computed according to the present teaching may then be used to implement a waterfall mechanism by acting as a multiplier to the original bid amount in place of the budget factor in online advertising.

Below, details related to dynamic wrapping functions to a budget factor are provided with illustrated two types of flows: primary and secondary flows, to enable a waterfall mechanism. Although the disclosure is presented with respect to two exemplary types of flows, the concept of utilizing wrapping functions to budget factor to determine preferred flows in different situations may be applied to more than two types of ad flows to implement a waterfall mechanism to any number of flow types in online advertising.

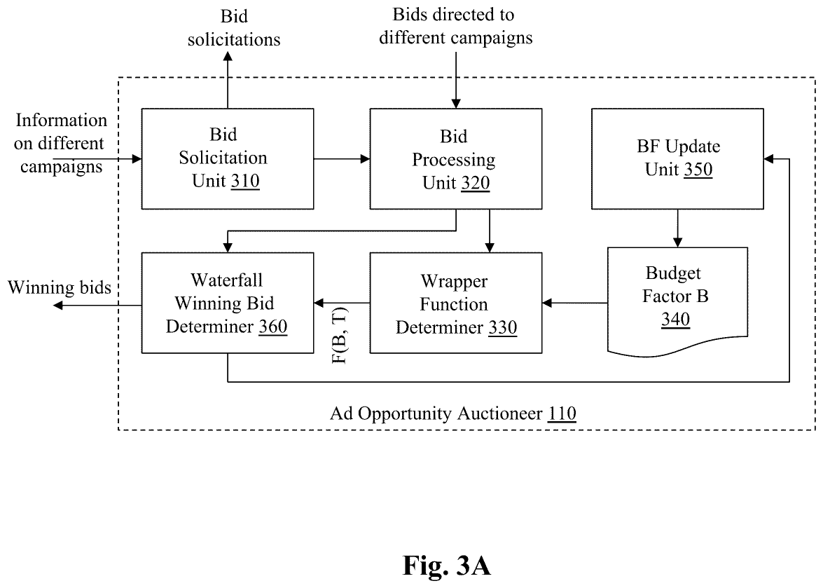

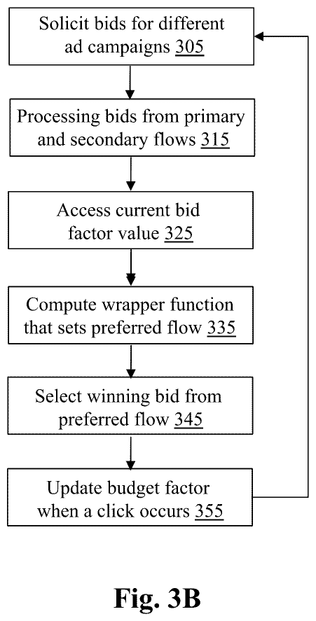

FIG. 3A depicts an exemplary high-level system diagram of the ad opportunity auctioneer 110, in accordance with an embodiment of the present teaching. In this illustrated embodiment, the ad opportunity auctioneer 110 comprises a bid solicitation unit 310, a bit processing unit 320, a wrapper function determiner 330, a waterfall winning bid determiner 360, and a BF update unit 350. In the ad opportunity auctioneer 110, a budget factor value B is stored in 340, used in online advertising processes, and may be updated dynamically by the BF update unit 350 based on the selection situations. The bid solicitation unit 310 may be provided for generating bid solicitations based on information about different ad campaigns. The bid processing unit 320 may be provided for receiving bids from different bidders directed to different campaigns and processes such bids.

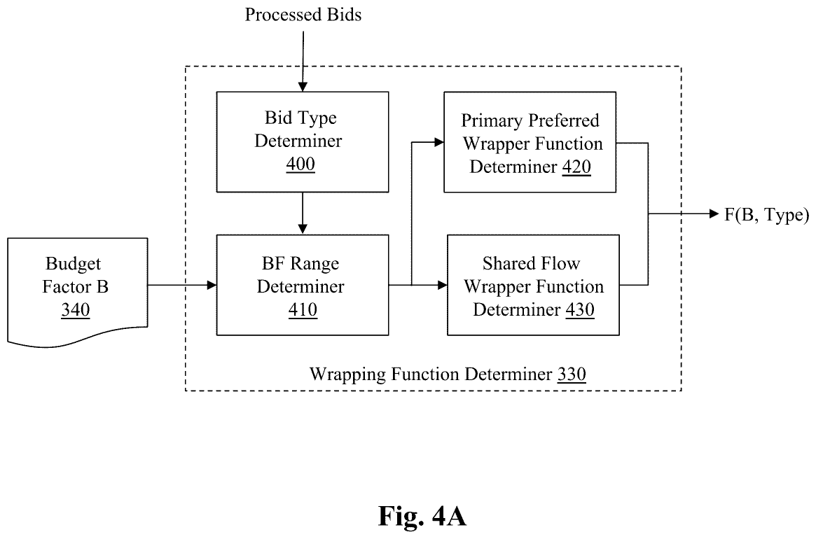

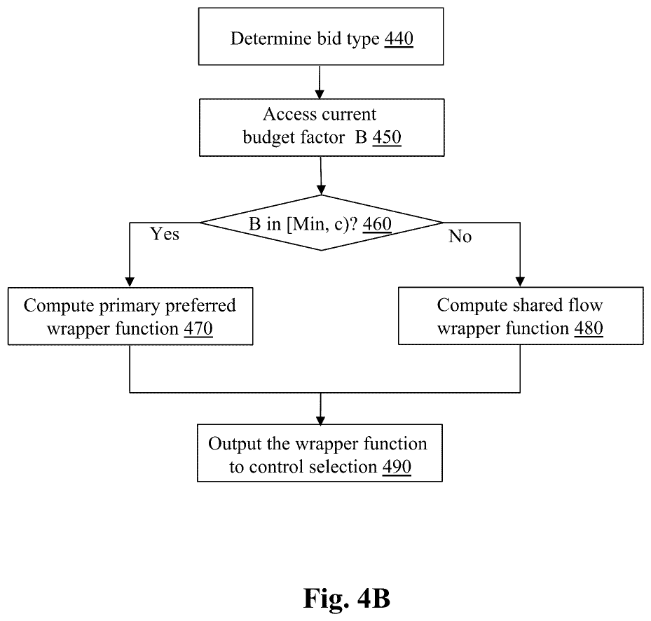

The wrapper function determiner 330 may be provided for taking the budget factor value B from storage 340 and compute the value of some wrapping functions F (B, T) according to the retrieved budget factor value B and each flow type T. Details related to the exemplary formulation of the wrapping functions and the computation thereof are provided with reference to FIGS. 4A-4B. The computed wrapper function values for different types of flows may then be provided to the waterfall winning bid determiner 360, where a winning bid is selected for each of the campaign's ads. Based on the winner selection, the BF update unit 350 is provided for updating the value of the budget factor value B in 340 associated with the winning ad when a click on the displayed ad is detected.

FIG. 3B depicts a flowchart of an exemplary process for the ad opportunity auctioneer 110, in accordance with an embodiment of the present teaching. As discussed herein, in operation, when the bid solicitation unit 310 receives information about one or more ad campaigns, it generates relevant solicitations for bids and sends, at 305, such solicitations for bids to appropriate destinations. When bids in response to the solicitations are received by the bid processing unit 320, the bids are processed at 315 and the processed bids are sent to the waterfall winning bid determiner 360. The wrapper function determiner 330 is activated to compute a wrapper function value for each bid based on the current budget factor. The wrapper function determiner 330 then accesses, at 325, the BF value from storage 340 and computes, at 335, the wrapper function value F (B, T) for each bid according to the flow types associated therewith. The computed wrapper function value for each bid is then sent to the waterfall winning bid determiner 360, which then selects, at 345, a winning bid for each ad campaign from a flow directed by the wrapping functions. Upon winning bid selected, the BF updates unit 350 then updates, at 355, the budget factor B accordingly.

FIG. 4A depicts an exemplary high-level system diagram of the wrapper function determiner 330, in accordance with an embodiment of the present teaching. As discussed herein, the wrapper function determiner 330 takes processed bids and the current budget factor value B as inputs and generates a computed wrapper function value F (B, T), wherein the type T of an ad flow is determined from a received bid, which may be known and received together with the bid. In some embodiments, assume that the range of budget factor is defined as [min, max], in some embodiments, exemplary wrapper functions may be defined as follows:

$$If B is in the range [ min , c ) ( where in one example , c = ( min + max ) / 2 :$$

$$If T = F ( B , T ) = ( max - min ) B / ( c - min ) + min [ 1 - ( max - min ) / ( c - min ) ] ;$$

$$If T = secondary F ( B , T ) = min .$$

This formulation may be provided to control the bidding process so that when a campaign is spending enough money to deplete the budget (i.e., B is in [min, c)), then the secondary flow shouldn't be encouraged to deplete more budget and instead, mostly the primary flow is to be selected to maximize the return. For example, if min=0, max=1, c=(min+max)/2=0.5, then F (B, T)=2*B when T=primary and F (B, T)=0 when T=secondary. In addition, If B is in the range [c, max]:

$$If T = primary F ( B , T ) = max ;$$

$$If T = secondary F ( B , T ) = ( max - min ) ( B - c ) / ( max - c ) + min$$

This formulation may be used to control the waterfall in the following manner. When the campaign is not spending enough budget, both the primary and secondary flows may be selected to consume the budget, but with a preference to the primary flow. If the campaign is not spending enough and B equals to max, then the campaign is to spend as much as possible on both types of flows so that in this case, both types have wrapper function values of max values. As the budget factor value B reduces, the wrapper function value F (B, T=CDC) for the secondary flow reduces as well.

For example, two ads related to two corresponding bids may be denoted respectively as A_{C} (a C2C ad) and A_{D} (a DPA ad). Assume that the range of the budget factor is [0, 1], the current budget factor value B is 0.25, and parameter a is 2. In this case, the computed wrapper function value F (B, T) for the C2C ad A_{C} is F (B, T=C2C)=0, i.e., the wrapper function value for A_{C} is zero. The computed wrapper function value F (B, T=DPA)=2*0.25=0.5, i.e., the wrapper function value for A_{D} is 0.5. Such wrapper function values associated with these two advertisements will be used in assessing a winner, as will be explained below.

It is noted that although an exemplary formulation is provided herein to show how a wrapper function may be used to implement a waterfall scheme, it is merely intended for illustration purpose and is not intended as a limitation. Different formulations for the wrapper function are entirely possible and they are all within the scope of the present teaching to utilize a wrapper function to control the spend of online advertising.

To implement such wrapper function computation, in the embodiment illustrated in FIG. 4A, the wrapper function determiner 330 includes a bid type determiner 400, a BF range determiner 410, a primary preferred wrapper function determiner 420, and a shared flow wrapper function determiner 430. The bid type determiner 400 is provided to determine the type T of each bid which is a parameter of computing the wrapper function values, as illustrated above. The BF range determiner 410 is provided for determining the current value of the budget factor B stored in storage 340, which is also a parameter to the wrapper functions. Depending on the type of each ad, the primary preferred wrapper function determiner 420 is provided to compute the wrapper function value when the current budget factor value B is in the first half of the budget factor range, i.e., [min, c), where c=(min+max)/2. The shared flow wrapper function determiner 430 is provided for computing the wrapper function value when the current budget factor value B is in the second half of the budget factor range, i.e., [c, max].

FIG. 4B depicts a flowchart of an exemplary process of the wrapper function determiner 330, in accordance with an embodiment of the present teaching. In this illustrated process, when processed bids are received from the bid processing unit 320, the bid type determiner 400 determines, at 440, the flow type of each of the bids received. To determine which of the wrapper function determiner (420 or 430), the BF range determiner 410 accesses, at 450, the current budget factor value B from storage 340 and determines, at 460, whether B is in the first half [min, c=(min+max)/2) of the BF range. If B is in [min, c=(min+max)/2), the primary preferred wrapper function determiner 420 is invoked to compute, at 470, the wrapper function value F (B, T). In some embodiments, the computation is in accordance with the formulation provided under the condition that B is in [min, c=(min+max)/2). If B is in [c=(min+max)/2, max], the shared flow wrapper function determiner 430 is invoked to compute, at 480, the wrapper function value F (B, T), e.g., in accordance with the formulation provided under the condition that B is in [c=(min+max)/2, max].

The computed wrapper function value F (B, T), either from the primary preferred wrapper function determiner 420 or the shared flow wrapper function determiner 430, is then output, at 490, to the waterfall winning bid determiner 360 (see FIG. 3A). As discussed herein, the computed wrapper function value F (B, T) is then used by the waterfall winning bid determiner 360 to select a winning bid. To select a winning bid, the received bids are ranked according to a score computed for each ad presented by a corresponding bid. For example, traditionally, a score used for ranking the ads presented by different bids may be defined as: S=p*Bid*Modifiers, where p represents the probability of a desired reaction to the ad, Bid represents the bid amount, and one of the modifiers corresponds to a budget factor value B. The probability may be computed with respect to a targeted desired return which may be, e.g., CTR or CVR. If it is targeted at CTR, then p is a function of pCTR, indicative of the probability of an ad that will lead to a click on the ad. If it is targeted at CVR, then p is a function of pCVR, indicative of the probability of a conversion on the ad.

According to the present teaching, rather than using the value B of the budget factor as a modifier in computing a ranking score, wrapper function value F (B, T) is instead used as a modifier in calculating a ranking score S′. That is, S=p*Bid*F (B, T) may be computed for each ad. Taking the above example of A_{C} and A_{D} and assuming B is in [0,0.5], then score S for A_{C} is: S(A_{C})=p(A_{C})*Bid*B*0=0 and score S′ for A_{D} is: S(A_{D})=p(A_{D})*Bid*B*2, which should be greater than zero, i.e., an ad from a DPA flow is ranked higher and, hence, has a better chance to be selected as a winning ad. In selecting a winning ad, bids are ranked according to S of the associated ads and an ad with a top S′ may then be selected as the winner. In this manner, selection of winning ads in online advertising may be dynamically steered to preferred flows under different budget spending conditions.

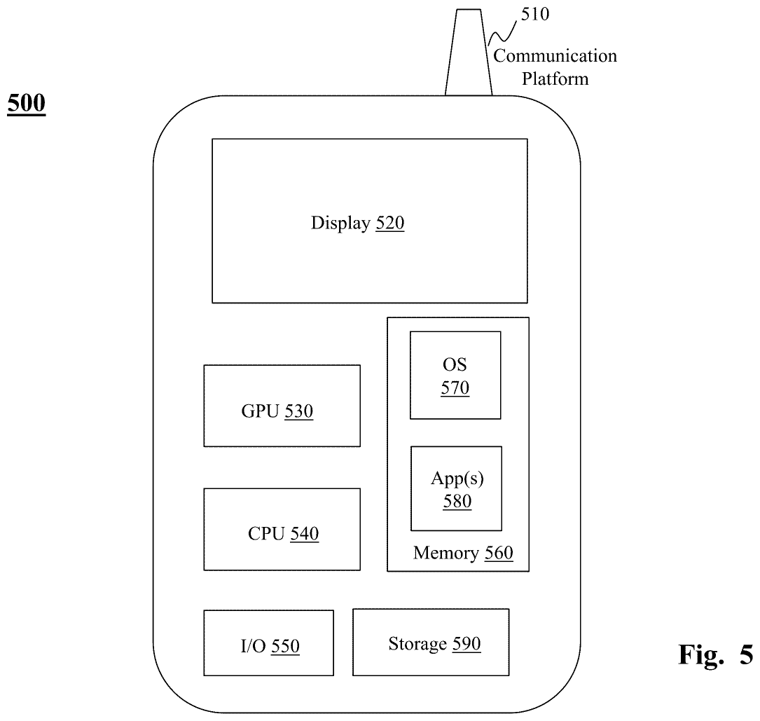

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.), and one or more applications 580 may be loaded into memory 560 from storage 590 in order to be executed by the CPU 540. The applications 580 may include a user interface or any other suitable mobile apps for information analytics and management according to the present teaching on, at least partially, the mobile device 500. User interactions, if any, may be achieved via the I/O devices 550 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with adapting those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

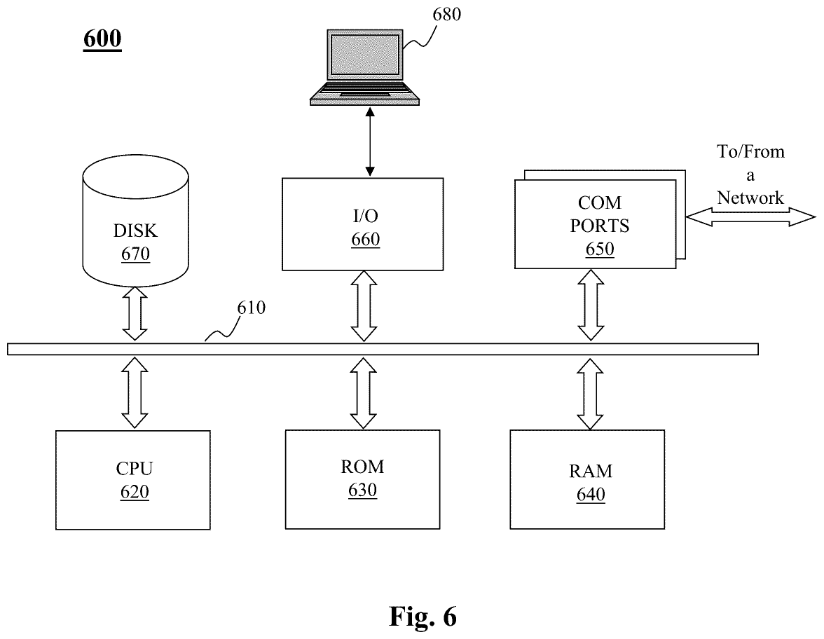

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information analytical and management method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware or a combination, hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method implemented on at least one processor, a memory, and a communication platform for online advertising, comprising:
soliciting bids from a plurality of bidders for identifying a winning advertisement with respect to an online ad display opportunity;
receiving bids from at least some of the plurality of bidders in response to the solicitation, wherein each of the received bids is associated with an advertisement from a certain type of advertisement flow;
retrieving, from a computer database, a current value of a budget factor that used to control budget pacing in online advertising;
for each of the received bids, computing a wrapper function value based on the current value of the budget factor and the type of flow of the advertisement associated with the bid, wherein the wrapper function value of the received bid indicates a preferred type of advertisement flow with respect to the received bid;
ranking the received bids in accordance with ranking scores for the respective received bids computed based on the wrapper function values of the respective advertisements associated therewith;
selecting a winning bid from the received bids based on the ranking scores; and
updating the budget factor based on detection of a click on the advertisement that is displayed.

2. The method of claim 1, wherein the type of flow includes:
a first type corresponding to a primary flow; and
a second type corresponding to a secondary flow.

3. The method of claim 2, wherein the step of computing a wrapper function comprises:
if the current value of the budget factor satisfies a first condition, computing the wrapper function value in accordance with a first definition; and
if the current value of the budget factor satisfies a second condition, computing the wrapper function value in accordance with a second definition.

4. The method of claim 2, wherein
the budget factor has a corresponding range between a minimum value and a maximum value;
the first condition specifies that the current value is within a first subrange of the range; and
the second condition specifies that the current value is within a second subrange of the range.

5. The method of claim 4, wherein the first definition includes:
if the advertisement is from the primary flow, the wrapper function value is set to be a function of the current value of the budget factor and a first predetermined constant; and
if the advertisement is from the secondary flow, the wrapper function value is set to be the minimum value, wherein
the wrapper function value computed based on the first definition represents a preference of an advertisement from a primary flow.

6. The method of claim 4, wherein the second definition includes:
if the advertisement is from the primary flow, the wrapper function value is set to be the maximum value; and
if the advertisement is from the secondary flow, the wrapper function value is set to be a multiplication of a difference between the current value and a midpoint of the range and a second predetermined constant, wherein
the wrapper function value computed based on the second definition allows selection of advertisements from either the primary flow or the secondary flow.

7. The method of claim 1, wherein each of the scores for an advertisement associated with one of the received bids is determined based on a bid value multiplied by the wrapper function value.

8. Machine readable and non-transitory medium having information recorded thereon, wherein the information, when read by the machine, causes the machine to perform the following steps:
soliciting bids from a plurality of bidders for identifying a winning advertisement with respect to an online ad display opportunity;
receiving bids from at least some of the plurality of bidders in response to the solicitation, wherein each of the received bids is associated with an advertisement from a certain type of advertisement flow;
retrieving, from a computer database, a current value of a budget factor that used to control budget pacing in online advertising;
for each of the received bids, computing a wrapper function value based on the current value of the budget factor and the type of flow of the advertisement associated with the bid, wherein the wrapper function value of the received bid indicates a preferred type of advertisement flow with respect to the received bid;
ranking the received bids in accordance with ranking scores for the respective received bids computed based on the wrapper function values of the respective advertisements associated therewith;
selecting a winning bid from the received bids based on the ranking scores; and
updating the budget factor based on detection of a click on the advertisement that is displayed.

9. The medium of claim 8, wherein the type of flow includes:
a first type corresponding to a primary flow; and
a second type corresponding to a secondary flow.

10. The medium of claim 9, wherein the step of computing a wrapper function comprises:
if the current value of the budget factor satisfies a first condition, computing the wrapper function value in accordance with a first definition; and
if the current value of the budget factor satisfies a second condition, computing the wrapper function value in accordance with a second definition.

11. The medium of claim 9, wherein
the budget factor has a corresponding range between a minimum value and a maximum value;
the first condition specifies that the current value is within a first subrange of the range; and
the second condition specifies that the current value is within a second subrange of the range.

12. The medium of claim 11, wherein the first definition includes:
if the advertisement is from the primary flow, the wrapper function value is set to be a function of the current value of the budget factor and a first predetermined constant; and
if the advertisement is from the secondary flow, the wrapper function value is set to be the minimum value, wherein
the wrapper function value computed based on the first definition represents a preference of an advertisement from a primary flow.

13. The medium of claim 11, wherein the second definition includes:
if the advertisement is from the primary flow, the wrapper function value is set to be the maximum value; and
if the advertisement is from the secondary flow, the wrapper function value is set to be a multiplication of a difference between the current value and a midpoint of the range and a second predetermined constant, wherein
the wrapper function value computed based on the second definition allows selection of advertisements from either the primary flow or the secondary flow.

14. The medium of claim 8, wherein each of the scores for an advertisement associated with one of the received bids is determined based on a bid value multiplied by the wrapper function value.

15. A system, comprising:
a bid solicitation unit implemented by a processor and configured for soliciting bids from a plurality of bidders for identifying a winning advertisement with respect to an online ad display opportunity;
a bid processing unit implemented by a processor and configured for receiving bids from at least some of the plurality of bidders in response to the solicitation, wherein each of the received bids is associated with an advertisement from a certain type of advertisement flow;
a wrapper function determiner implemented by a processor and configured for
retrieving, from a computer database, a current value of a budget factor used to control budget pacing in online advertising, and
for each of the received bids, computing a wrapper function value based on the current value of the budget factor and the type of flow of the advertisement associated with the bid, wherein the wrapper function value of the received bid indicates a preferred type of advertisement flow with respect to the received bid;
a waterfall winning bid determiner implemented by a processor and configured for ranking the received bids in accordance with ranking scores for the respective received bids computed based on the wrapper function values of the respective advertisements associated therewith, and
selecting a winning bid from the received bids based on the ranking scores; and
an update unit implemented by a processor and configured for
updating the budget factor based on detection of a click on the advertisement that is displayed.

16. The system of claim 15, wherein
the type of flow includes:
a first type corresponding to a primary flow, and
a second type corresponding to a secondary flow,
the budget factor has a corresponding range between a minimum value and a maximum value;
the first condition specifies that the current value is within a first subrange of the range; and
the second condition specifies that the current value is within a second subrange of the range.

17. The system of claim 16, wherein the wrapper function determiner comprises:
a primary preferred wrapper function determiner implemented by a processor and configured for computing the wrapper function value in accordance with a first definition when the current value of the budget factor satisfies a first condition; and
a shared flow wrapper function determiner implemented by a processor and configured for computing the wrapper function value in accordance with a second definition when the current value of the budget factor satisfies a second condition.

18. The system of claim 17, wherein the first definition includes:
if the advertisement is from the primary flow, the wrapper function value is set to be a function of the current value of the budget factor and a first predetermined constant; and
if the advertisement is from the secondary flow, the wrapper function value is set to be the minimum value, wherein
the wrapper function value computed based on the first definition represents a preference of an advertisement from a primary flow.

19. The system of claim 17, wherein the second definition includes:
if the advertisement is from the primary flow, the wrapper function value is set to be the maximum value; and
if the advertisement is from the secondary flow, the wrapper function value is set to be a multiplication of a difference between the current value and a midpoint of the range and a second predetermined constant, wherein
the wrapper function value computed based on the second definition allows selection of advertisements from either the primary flow or the secondary flow.

20. The system of claim 15, wherein each of the scores for an advertisement associated with one of the received bids is determined based on a bid value multiplied by the wrapper function value.
